(19) United States
(12) Patent Application Publication
(10) Pub. No.: US 2009/0241262 A1
(43) Pub. Date: Oct. 1, 2009

(54) Mobile veterinary surgical table incorporating a dental operatory

(76) Inventor: Frank Jehn, Toms River, NJ (US)

Correspondence Address: CLIFFORD G. FRAYNE;Suite 7A, 136 Drum Point Road, Brick, NJ, 08723, US

(21) Appl. No.: 12/383,517

(22) Filed: Mar. 25, 2009

Related U.S. Application Data
(60) Provisional application No. 61/072,128, filed on Mar. 28, 2008.

(51) Int. Cl. A61G 13/10; A61G 13/12; A61G 13/04; A47B 7/02

(52) U.S. Cl. 5/606; 5/613; 5/616; 5/607

(57) ABSTRACT

A mobile veterinary surgical table incorporating a dental operatory, the mobile veterinary surgical table having a base member having a mobility means, a support pedestal member mounted to the base frame member allowing height adjustment of the support surface of the veterinary surgical table, the veterinary surgical support being bifurcated so as to be angularly oriented from the horizontal to a V-shape, the veterinary support member being tiltable at a desired angle and having a runoff tray positioned beneath the support surface for the disposition of fluids, there being positioned at one end of the support surface a dental tray, there being positioned on the base frame beneath the support surface a dental operatory, including all of the tools required for the operation of the dental operatory for performing dental treatment of the animal while its head is positioned on the dental tray.

### RELATED APPLICATIONS

Applicant claims the priority of provisional application Ser. No. 61/072,128, filed May 28, 2008.

### BACKGROUND OF THE INVENTION

1. Field of the Invention

The present invention relates to veterinary surgical tables, and in particular, to a veterinary surgical table which allows the user to adjust the table to any selected height and angle for the transport, transfer or examination of an animal, and incorporates a dental operatory.

2. Description of the Prior Art

Veterinary surgical tables are used to support dogs, cats and other small animals during examination or surgery. It is desirable that the veterinarian or assistant be able to elevate the table and the animal to facilitate such examination or surgery, and it is further desirable to be able to incline or angularly tilt the supporting surface in order to properly orientate the animal and to assist in the runoff of fluids.

Heretofore however, no surgical table has also incorporated a complete dental operatory in association with the surgical table, which would allow the veterinarian or assistant to examine the animal and to also perform dental treatment without having to transfer the animal.

The mobile veterinary surgical table of the present invention allows the veterinarian or assistant to elevate the animal to a desired height, tilt or angularly orient the table as desired, incorporates a dental tray at one end to facilitate the dental treatment of the animal, and incorporates all of the dental equipment on the mobile base below the support surface for performing dental operatory work and eliminates the need for two separate tables.

### OBJECTS OF THE INVENTION

An object of the present invention is to provide for a novel veterinary surgical table which is mobile and which incorporates a dental operatory for performing dental treatment on the animal without having to transfer the animal to a separate and distinct table thereby eliminating the requirement of two separate tables.

A further object of the present invention is to provide for a novel veterinary surgical table which is mobile and which can be adjusted in height and angular orientation as desired by the veterinarian.

Another object of the present invention is to provide for a novel veterinary surgical table in which all of the dental tools and equipment required of a dental operatory are positioned on the base of the veterinary surgical table beneath the support surface when the veterinary table is being utilized as a surgical table.

### SUMMARY OF THE INVENTION

A mobile veterinary surgical table incorporating a dental operatory, the mobile veterinary surgical table having a base member having a mobility means, a support pedestal member mounted to the base frame member allowing height adjustment of the support surface of the veterinary surgical table, the veterinary surgical support being bifurcated so as to be angularly oriented from the horizontal to a V-shape, the veterinary support member being tiltable at a desired angle and having a runoff tray positioned beneath the support surface for the disposition of fluids, there being positioned at one end of the support surface a dental tray, there being positioned on the base frame beneath the support surface a dental operatory, including all of the tools required for the operation of the dental operatory for performing dental treatment of the animal while its head is positioned on the dental tray.

### BRIEF DESCRIPTION OF THE DRAWINGS

These and other objects of the present invention will become evident, particularly when taken in light of the following illustrations wherein:

FIG. 1 is a perspective view of the veterinary surgical table and dental operatory of the present invention.

### DETAILED DESCRIPTION OF THE DRAWINGS

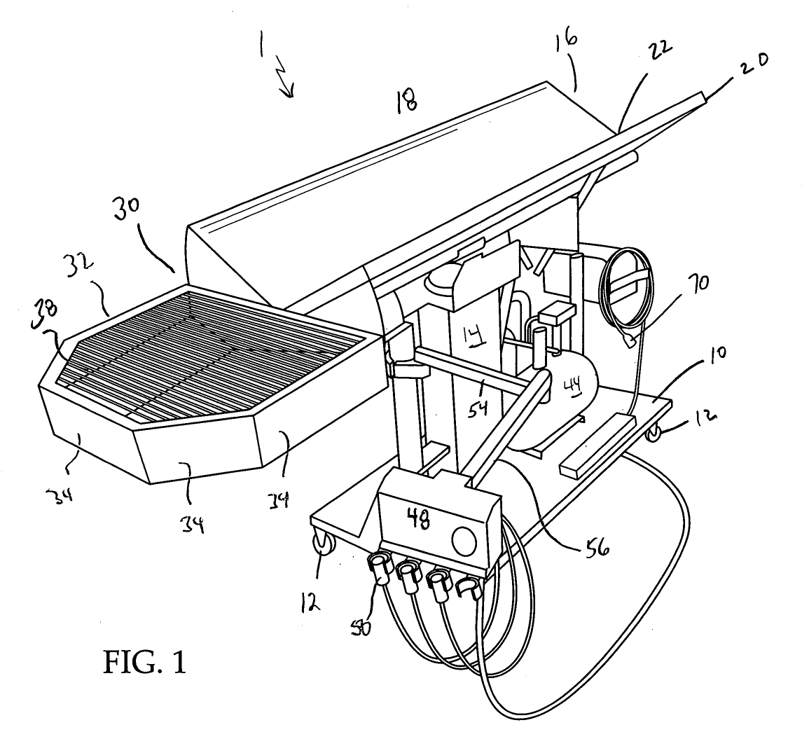

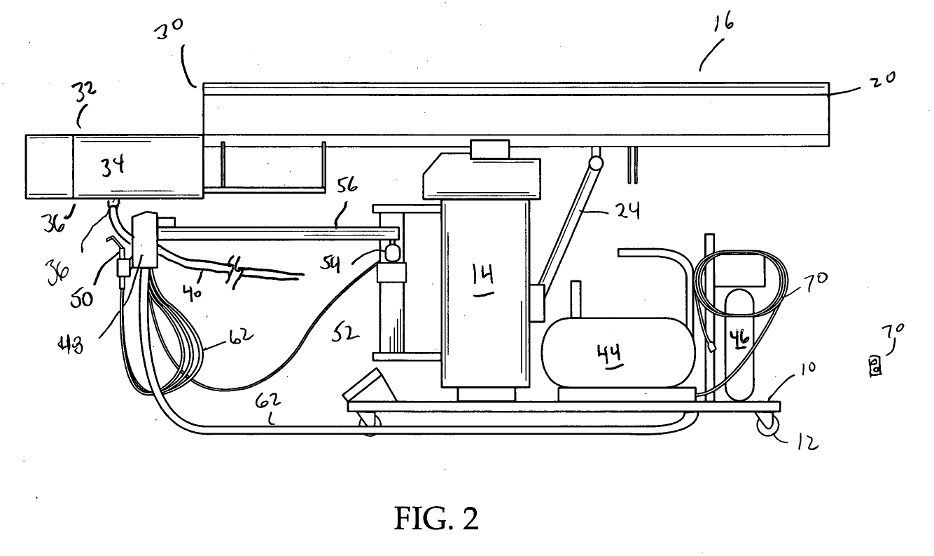

FIG. 1 is a perspective view of a mobile veterinary surgical operatory table 1 incorporating a dental operatory. FIG. 2 is a side elevational view of the mobile veterinary surgical operatory table 1 incorporating a dental operatory. A typical surgical operatory table would include a base member 10 mounted on a mobile means in the form of wheels 12. Supported on base 10 would be a pedestal mount 14 upon which a bifurcated surgical table 16 would be mounted. Bifurcated surgical table 16 would be formed of two identical rotatable panels 18 and 20 having a gap 22 between the two panels. Underneath the two panels 18 and 20 in the gap 22 would be a collection tray (not shown) for the collection of blood and fluids. The bifurcated V-shaped surgical table 16 would be tiltable by means of a gas pressurized cylinder 24 or similar pressure assisted means either manually or foot operated.

The surgical table thus described would be modified to include a dental operatory in the following manner. At a first end 30 of the operatory table 1 there would be stationed a dental tray 32 defined by side walls 34, a bottom wall 36, and an upper mesh grid 38. The animal or pet would be positioned on the operatory table with its head resting on the dental tray 32. The dental tray 32 may include an outlet in its bottom wall 36 connected to a flexible hose 40 which would channel fluids and detritus to a collection chamber such as that of the collection tray beneath the operatory table 1. The dental tray and mesh grid 32 and 38 may also be removable and separable for cleaning and sterilization.

On the base member 10 of the surgical operatory table 1 there may be a compressor means 44 and a water source 46 similar to that found in a human dental operatory for the operation of dental implements. Also articulatingly mounted on the base member would be a control panel 48 for the dental instruments 50 removably secured thereto. This articulation would be accomplished by a vertical post 52 secured to the pedestal mount 14 or to the base member 10, and two articulating arms 54 and 56 which would allow the control panel 48 to be positioned proximate the dental tray 32 when dental operatory was in progress, and to be articulatingly stored beneath the bifurcated surgical table 16 when not in use. The various instruments 50 (e.g. drill, suction hose, drying hose) on the control panel 48 would be connected by flexible tubing 62 to the respective water source 46 or compressor means 44, which in turn would be electrically connected to a power source 70 or instruments 50 may be directly connected to power source 70.

In the embodiment disclosed, the mobile surgical table may be used strictly for animal surgery or a combination of animal surgery and dental operatory for the animal. Many times it is more convenient to attend to the dental aspects of the animal or pet simultaneously with any surgical procedures being performed in that it eliminates the need for a secondary anesthetic. The table thus described also eliminates the need for two separate surgery tables.

While the present invention has been described with respect to the preferred embodiment thereof, it will be recognized by those of ordinary skill in the art that many changes and modifications may be made without departing from the spirit and scope of the invention.

I claim:

1. A veterinary surgical table incorporating a dental operatory, said veterinary surgical table and dental operatory comprising:
a longitudinally bifurcated upper surface for support of an animal to be treated, said longitudinally bifurcated upper surface positionable from horizontal to V-shape;
a support pedestal for supporting said upper surface and for elevating and lowering said upper surface and tilting said upper surface in an inclined position and the plurality of positions there between;
a mobile base member for support of said support pedestal and said longitudinally bifurcated upper surface;
a control member for controlling the elevation, lowering and inclining of said upper surface, and locking said upper surface in said position;
a dental tray positioned at one end of said upper support surface, said dental tray for the support of the head and jaw of said animal being treated.

2. The veterinary surgical table in combination with the dental operatory in accordance with claim 1 wherein a dental operatory control panel is articulatingly mounted on said mobile base member and slidably maneuverable from under said upper support surface to proximate said dental tray, said control panel including removably secured dental instruments for performing dental procedures within the oral cavity of said animal being treated; said dental instruments being in communication with a source of electrical power and a compressor means for performing said dental procedures.

3. The veterinary surgical table and dental operatory in accordance with claim 2 wherein said dental tray is removably secured to one end of said upper support surface to facilitate cleaning and sterilization.

4. The veterinary surgical table and dental operatory in accordance with claim 3 wherein said dental tray is formed with a removable upper surface having a plurality of apertures and/or mesh surface to facilitate the passage of fluids and detritus into said dental tray.

5. The veterinary surgical table incorporating a dental operatory in accordance with claim 1 wherein said dental tray includes an outlet drain in communication with a collection chamber for the collection of fluids and detritus from said dental tray.

6. The veterinary surgical table and dental operatory in accordance with claim 1 wherein when said veterinary surgical table and dental operatory is not required for use as a dental operatory, said dental tray is removable and said dental operatory control panels and instruments are articulatingly positioned and stored under said upper support surface permitting said veterinary surgical table and combination dental operatory to perform as a veterinary surgical table only.
